(19) United States
(12) Patent Application Publication
(10) Pub. No.: US 2026/0217962 A1
(43) Pub. Date: Jul. 30, 2026

(54) THERMOPLASTIC COMPOSITION, METHOD FOR THE MANUFACTURE THEREOF, AND ARTICLES MADE THEREFROM

(71) Applicant: SHPP GLOBAL TECHNOLOGIES B.V., Bergen op Zoom (NL)

(72) Inventors: Keran Chen, Shanghai (CN); Wei Shan, Shanghai (CN); Yun Zheng

(21) Appl. No.: 19/145,225

(22) PCT Filed: Nov. 1, 2023
(86) PCT No.: PCT/IB2023/060996

§ 371 Date: Jul. 2, 2025

(30) Foreign Application Priority Data
Jan. 5, 2023 (EP) 23150475.4

(51) Int. Cl. C08L 33/12; C08J 3/20; C08K 5/103; C08K 5/524

(52) U.S. Cl. CPC C08L 33/12; C08J 3/203; C08K 5/103; C08K 5/524; C08J 2333/12; C08J 2453/02

(57) ABSTRACT

A thermoplastic composition includes particular amounts of a poly(methyl methacrylate) and a radial hydrogenated block copolymer of an alkenyl aromatic and a conjugated diene having a particular alkenyl aromatic content. Methods for making the composition and articles made from the composition are also provided.

### CROSS REFERENCE TO RELATED APPLICATION

This application claims priority to and the benefit of European Patent Application No. 23150475.4, filed on Jan. 5, 2023, the contents of which are hereby incorporated by reference in their entirety.

### BACKGROUND

This disclosure relates to thermoplastic compositions, particularly to thermoplastic compositions having low dielectric constant, low dissipation factor, and good mechanical properties, methods for the manufacture thereof, and articles comprising the composition.

Impact modified compositions are of interest for providing a balance of desirable properties, including impact strength, flowability, chemical resistance, and dielectric properties. A class of impact modified compositions is based on poly(methyl methacrylate). For example, core-shell impact modifiers have been mixed with poly(methyl methacrylate) in an attempt to provide enhanced impact strength without affecting optical performance. However, the dielectric properties are not tunable, and therefore such blends are limited in terms of applications. In particular, applications in electronics require certain dielectric properties.

Accordingly, it would be advantageous to provide an impact modified poly(methyl methacrylate) composition with low dielectric constant and low dissipation factor. It would be a further advantage to provide a composition having high impact resistance.

### SUMMARY

An aspect of the present disclosure is a thermoplastic composition comprising: 70 to 99 weight percent of poly(methyl methacrylate); and 1 to 30 weight percent of a radial hydrogenated block copolymer of an alkenyl aromatic and a conjugated diene having an alkenyl aromatic content of 10 to 20 weight percent based on the total weight of the hydrogenated block copolymer; wherein weight percent of each component is based on the total weight of the thermoplastic composition; wherein the combined amount of the poly(methyl methacrylate) and the hydrogenated block copolymer is at least 90 weight percent; and wherein a molded sample of the thermoplastic composition exhibits one or more of: a dielectric constant Dk of 2.45 to 2.75 at 1.9 GHz; a dielectric loss Df of less than 0.01 at 1.9 GHz; a transmission of greater than 90% at a thickness of 2 millimeters or 3 millimeters, according to ASTM D1003; a haze of less than 4% at a thickness of 2 millimeters, according to ASTM D1003; and a haze of less than 8% at a thickness of 3 millimeters, according to ASTM D100.

Another aspect of the present disclosure is a method for the manufacture of the thermoplastic composition, the method comprising melt-mixing the components of the composition.

Another aspect of the present disclosure is an article comprising the composition.

The above described and other features are exemplified by the following detailed description.

### DETAILED DESCRIPTION

The present inventors have unexpectedly found that a thermoplastic composition comprising particular amounts of poly(methyl methacrylate) and a specific nonpolar impact modifier can provide a desirable combination of properties. In particular, the composition can provide good impact strength, optical properties, and dielectric properties.

Accordingly, an aspect of the present disclosure is a thermoplastic composition. The composition comprises a poly(methyl methacrylate). Poly(methyl methacrylate), also referred to as “PMMA”, comprises repeating units derived from polymerization of methyl methacrylate. The poly(methyl methacrylate) can be obtained by free radical polymerization. Preferably, the poly(methyl methacrylate) is a methyl methacrylate homopolymer and repeating units derived from other monomers are excluded from the polymer.

The weight average molecular weight (Mw) of the poly(methyl methacrylate) can vary within a wide range, the Mw usually being matched to the intended use and to the mode of processing of the composition. In an aspect, the Mw of the poly(methyl methacrylate) can be 20,000 to 1,000,000 grams per mole (g/mol), or 50,000 to 500,000 g/mol or 80,000 to 300,000 g/mol, determined in accordance with ASTM D5296-11. In an aspect, the poly(methyl methacrylate) can have a melt volume flow rate (MVR) of 6 cubic centimeters per 10 minutes (cm³/10 min) to 18 cm³/10 at 230° C., 3.8 kilograms (kg), as measured in accordance with ISO 1133 or ASTM D1238.

The poly(methyl methacrylate) can be present in the composition in an amount of 70 to 99 weight percent, based on the total weight of the composition. Within this range, the poly(methyl methacrylate) can be present in an amount of 75 to 99 weight percent, or 77 to 98 weight percent, or 70 to 95 weight percent, or 78 to 99 weight percent, or 80 to 99 weight percent, or 80 to 95 weight percent, or 78 to 92 weight percent, or 85 to 98 weight percent, each based on the total weight of the composition.

In addition to the poly(methyl methacrylate), the thermoplastic composition comprises a hydrogenated block copolymer of an alkenyl aromatic and a conjugated diene. The hydrogenated block copolymer is a nonpolar impact modifier which, without wishing to be bound by theory, is believed to contribute to the desirable combination of properties obtained for the present compositions. For brevity, this component is referred to as the “hydrogenated block copolymer”.

The present inventors have found that the desired combination of properties can be obtained when the hydrogenated block copolymer comprises 10 to 20 weight percent of poly(alkenyl aromatic) content and 80 to 90 weight percent of hydrogenated poly(conjugated diene) content, based on the weight of the hydrogenated block copolymer. In an aspect, the hydrogenated block copolymer can have an alkenyl aromatic content of 10 to 15 weight percent, based on the total weight of the hydrogenated block copolymer. The hydrogenated block copolymer of the present disclosure further has a radial architecture.

In an aspect, the hydrogenated block copolymer can have a specific gravity of greater than 0.91 g/cm³, or greater than or equal to 0.92 g/cm³, or greater than or equal to 0.93 g/cm³.

In an aspect, the hydrogenated block copolymer has a weight average molecular weight of 40,000 to 400,000 g/mol. The number average molecular weight and the weight average molecular weight can be determined by gel permeation chromatography and based on comparison to polystyrene standards. In an aspect, the hydrogenated block copolymer has a weight average molecular weight of 200,000 to 400,000 g/mol, or 220,000 to 350,000 g/mol. In an aspect, the hydrogenated block copolymer has a weight average molecular weight of 40,000 to 200,000 g/mol, or 40.000 to 180,000 g/mol, or 40,000 to 150,000 g/mol.

The alkenyl aromatic monomer used to prepare the hydrogenated block copolymer can have the structure according to formula (6)

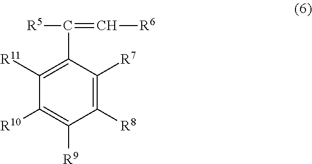

wherein R⁵ and R⁶ each independently represent a hydrogen atom, a C₁₋₈ alkyl group, or a C₂₋₈ alkenyl group; R⁷ and R¹¹ each independently represent a hydrogen atom, a C₁₋₈ alkyl group, a chlorine atom, or a bromine atom; and R⁸, R⁹, and R¹⁰ each independently represent a hydrogen atom, a C₁₋₈alkyl group, or a C₂₋₈alkenyl group, or R⁸ and R¹⁰ are taken together with the central aromatic ring to form a naphthyl group, or R⁹ and R¹⁰ are taken together with the central aromatic ring to form a naphthyl group. Specific alkenyl aromatic monomers include, for example, styrene, chlorostyrenes such as p-chlorostyrene, methylstyrenes such as alpha-methylstyrene and p-methylstyrene, and t-butylstyrenes such as 3-t-butylstyrene and 4-t-butylstyrene. In an aspect, the alkenyl aromatic monomer is styrene.

The conjugated diene used to prepare the hydrogenated block copolymer can be a C₄₋₂₀ conjugated diene. Suitable conjugated dienes include, for example, 1,3-butadiene, 2-methyl-1,3-butadiene, 2-chloro-1,3-butadiene, 2,3-dimethyl-1,3-butadiene, 1,3-pentadiene, 1,3-hexadiene, and the like, and combinations thereof. In an aspect, the conjugated diene is 1,3-butadiene, 2-methyl-1,3-butadiene, or a combination thereof. In an aspect, the conjugated diene is 1,3-butadiene.

The hydrogenated block copolymer is a copolymer comprising (A) at least one block derived from an alkenyl aromatic compound and (B) at least one block derived from a conjugated diene, in which the aliphatic unsaturated group content in the block (B) is at least partially reduced by hydrogenation. In an aspect, the aliphatic unsaturation in the (B) block is reduced by at least 50 percent, or at least 70 percent. The arrangement of blocks (A) and (B) can be in a radial teleblock structure with or without a branched chain. In an aspect, the hydrogenated block copolymer is a diblock copolymer, a triblock copolymer, or a combination thereof.

In an aspect, the hydrogenated block copolymer excludes the residue of monomers other than the alkenyl aromatic compound and the conjugated diene. In an aspect, the hydrogenated block copolymer consists of blocks derived from the alkenyl aromatic compound and the conjugated diene. It does not comprise grafts formed from these or any other monomers. It also consists of carbon and hydrogen atoms and therefore excludes heteroatoms. In an aspect, the hydrogenated block copolymer includes the residue of one or more acid functionalizing agents, such as maleic anhydride. In an aspect, the hydrogenated block copolymer comprises a polystyrene-poly(ethylene-butylene)-polystyrene triblock copolymer.

Methods for preparing hydrogenated block copolymers are known in the art and many hydrogenated block copolymers are commercially available.

The hydrogenated block copolymer can be present in the thermoplastic composition in an amount of 1 to 30 weight percent, based on the total weight of the composition. Within this range, the hydrogenated block copolymer can be present in an amount of 1 to 25 weight percent, or 2 to 23 weight percent, or 5 to 30 weight percent, or 1 to 22 weight percent, or 1 to 20 weight percent, or 5 to 20 weight percent, or 8 to 22 weight percent, or 2 to 15 weight percent, each based on the total weight of the thermoplastic composition.

In an aspect, impact modifiers other than the hydrogenated block copolymer can be minimized (i.e., present in an amount of less than 1 weight percent) or excluded from the thermoplastic composition. For example, a homopolystyrene, a high impact polystyrene, or a core-shell impact modifier can be excluded from the composition. In an aspect, hydrogenated block copolymers having an alkenyl aromatic content of greater than 20 weight percent can be minimized or excluded from the composition. For example, hydrogenated block copolymers having an alkenyl aromatic content of greater than 20 weight percent can be present in an amount of 5 weight percent or less, or 1 weight percent or less, or 0.5 weight percent or less, or 0.1 weight percent or less. In an aspect, hydrogenated block copolymers having an alkenyl aromatic content of greater than 20 weight percent are excluded from the composition. In an aspect, hydrogenated block copolymers having a linear architecture can be excluded from the composition.

The combined amount of the poly(methyl methacrylate) and the hydrogenated block copolymer is at least 90 weight percent, or at least 92 weight percent, or at least 95 weight percent, or at least 97 weight percent, or at least 99 weight percent. Stated another way, the composition can comprise 10 weight percent or less, or 8 weight percent or less, or 5 weight percent or less, or 3 weight percent or less, or 1 weight percent or less of a component other than the poly(methyl methacrylate) and the hydrogenated block copolymer having an alkenyl aromatic content of 10 to 20 weight percent.

In a specific aspect, the thermoplastic composition can comprise 75 to 99 weight percent, or 77 to 98 weight percent of the poly(methyl methacrylate); and 1 to 25 weight percent, or 2 to 23 weight percent of the radial hydrogenated block copolymer, wherein the radial hydrogenated block copolymer has an alkenyl aromatic content of 10 to 15 weight percent based on the total weight of the radial hydrogenated block copolymer. The radial hydrogenated block copolymer can be a poly(styrene-ethylene/butylene-styrene) radial triblock copolymer.

The thermoplastic composition can optionally further comprise an additive composition. The additive composition comprises one or more additives. The additives can be, for example, stabilizers, mold release agents, lubricants, processing aids, drip retardants, nucleating agents, UV blockers, dyes, pigments, antioxidants, anti-static agents, blowing agents, mineral oil, metal deactivators, antiblocking agents, or a combination thereof. In an aspect, the additive composition can comprise an antioxidant. When present, such additives are typically used in a total amount of 0.1 to 10 weight percent, based on the total weight of the composition.

Antioxidant additives can include organophosphites such as tris(nonyl phenyl)phosphite, tris(2,4-di-t-butylphenyl)phosphite, bis(2,4-di-t-butylphenyl)pentaerythritol diphosphite, distearyl pentaerythritol diphosphite; alkylated monophenols or polyphenols; alkylated reaction products of polyphenols with dienes, such as tetrakis[methylene(3,5-di-tert-butyl-4-hydroxyhydrocinnamate)]methane; butylated reaction products of para-cresol or dicyclopentadiene; alkylated hydroquinones; hydroxylated thiodiphenyl ethers; alkylidene-bisphenols; benzyl compounds; esters of beta-(3,5-di-tert-butyl-4-hydroxyphenyl)-propionic acid with monohydric or polyhydric alcohols; esters of beta-(5-tert-butyl-4-hydroxy-3-methylphenyl)-propionic acid with monohydric or polyhydric alcohols; esters of thioalkyl or thioaryl compounds such as distearylthiopropionate, dilaurylthiopropionate, ditridecylthiodipropionate, octadecyl-3-(3,5-di-tert-butyl-4-hydroxyphenyl)propionate, pentaerythrityl-tetrakis[3-(3,5-di-tert-butyl-4-hydroxyphenyl)propionate; amides of beta-(3,5-di-tert-butyl-4-hydroxyphenyl)-propionic acid, or a combination thereof. Antioxidants can be used in amounts of 0.01 to 0.5 weight percent, or 0.01 to 0.1 weight percent, based on the total weight of the composition.

The composition can optionally minimize or exclude additional components not specifically described herein. For example, the composition comprises less than 5 weight percent, or less than 2 weight percent, or less than 1 weight percent or less than 0.1 weight percent of a thermoplastic polymer other than the foregoing polymers of the present composition. In an aspect, the composition can minimize or exclude homopolystyrene, rubber-modified polystyrene, or a core-shell impact modifier.

The composition according to the present disclosure can exhibit a desirable combination of properties. For example, a molded sample of the composition can exhibit a dielectric constant Dk of 2.45 to 2.75 at 1.9 gigahertz (GHz). A molded sample of the composition can exhibit a dielectric loss Df of less than 0.01 at 1.9 GHz. A molded sample of the composition can exhibit a transmission of greater than 90% at a thickness of 2 millimeters or 3 millimeters, according to ASTM D1003. A molded sample of the composition can exhibit a haze of less than 4% at a thickness of 2 millimeters, according to ASTM D1003. A molded sample of the composition can exhibit a haze of less than 8% at a thickness of 3 millimeters, according to ASTM D1003. A molded sample of the composition can exhibit a notched Izod impact strength of at least 15 Joules per meter (J/m) at room temperature, 0° C., −30° C., or −40° C., each determined according to ASTM D648. A molded sample of the composition can exhibit one or more of the foregoing properties. In an aspect, a molded sample of the composition exhibits each of the foregoing properties.

In a specific aspect, the thermoplastic composition of the present disclosure can comprise 75 to 99 weight percent of the poly(methyl methacrylate); and 1 to 25 weight percent of a radial poly(styrene-ethylene/butylene-styrene) triblock copolymer having a styrene content of 10 to 15 weight percent based on the total weight of the radial hydrogenated block copolymer; wherein the amounts of the poly(methyl methacrylate) and the radial poly(styrene-ethylene/butylene-styrene) triblock copolymer sum to at least 95 weight percent, based on the total weight of the composition; and wherein a molded sample of the thermoplastic composition exhibits one or more of: a dielectric constant Dk of 2.45 to 2.75 at 1.9 GHz; a dielectric loss Df of less than 0.01 at 1.9 GHz; a transmission of greater than 90% at a thickness of 2 millimeters or 3 millimeters, according to ASTM D1003; a haze of less than 4% at a thickness of 2 millimeters, according to ASTM D1003; and a haze of less than 8% at a thickness of 3 millimeters, according to ASTM D1003.

The composition of the present disclosure can be manufactured, for example, by melt blending the components of the composition. The components of the composition can be mixed or blended using common equipment such as ribbon blenders. HENSCHEL™ mixers, BANBURY™ mixers, drum tumblers, and the like, and the blended composition can subsequently be melt-blended or melt-kneaded. The melt-blending or melt-kneading can be performed using common equipment such as single-screw extruders, twin-screw extruders, multi-screw extruders, co-kneaders, and the like. For example, the present composition can be prepared by melt-blending the components in a twin-screw extruder at a temperature of 50 to 210° C. The extrudate can be immediately quenched in a water bath and pelletized. The pellets so prepared can be one-fourth inch long or less as desired. Such pellets can be used for subsequent molding, shaping, or forming.

Shaped, formed, or molded articles comprising the composition represent another aspect of the present disclosure. The composition can be molded into useful shaped articles by a variety of methods, such as injection molding, extrusion, rotational molding, blow molding and thermoforming. The article can be a consumer product. In some aspects the article can be an automotive component. In some aspects, the article can be consumer electronic housing. Example articles include, but are not limited to, exterior automobile components (grill, mirror housing, pillar, spoiler, logo, roof rail, bezel, trim, fender, etc.), interior automobile components (decorative parts, electronic housings, instrument panel components, navigation system, housing frames, etc.), storage boxes, a personal equipment part, a home appliance component, furniture, appliance housings (e.g., robot cleaners, drones, etc.), and consumer electronics devices (e.g., device housings or components for laptops, phones, tablets, batteries, wireless charging. AR/VR goggles, etc.). Exemplary multilayer articles include but are not limited to a cap-layer in sheet, a top-layer or an intermediate layer in a multi-layer assembly (e.g., for electronics, photovoltaics, (O)LED), film for insert molding or in-mold decoration, top-layer for composite, etc.). In some aspects the article can be an automotive bumper, an automotive exterior component, an automobile mirror housing, an automobile wheel cover, an automobile instrument panel or trim, an automobile glove box, an automobile door hardware or other interior trim, an automobile exterior light, an automobile part within the engine compartment, an agricultural tractor or device part, a window or a component thereof, a construction equipment vehicle or device part, a marine or personal water craft part, an all-terrain vehicle or all-terrain vehicle part, plumbing equipment, a valve or pump, an air conditioning heating or cooling part, a furnace or heat pump part, a computer housing, a computer housing or business machine housing or part, a housing or part for monitors, a computer router, a desk top printer, a large office/industrial printer, an electronics part, a projector part, an electronic display part, a copier part, a scanner part, an electronic printer toner cartridge, a handheld electronic device housing, a housing for a hand-held device, a hair drier, an iron, a coffee maker, a toaster, a washing machine or washing machine part, a microwave, an oven, a power tool, an electric component, an electric enclosure, a lighting part, a component for a lighting fixture, a dental instrument, a medical instrument, a medical or dental lighting part, an aircraft part, a train or rail part, a seating component, a sidewall, a ceiling part, cookware, a medical instrument tray, an animal cage, fibers, a laser welded medical device, fiber optics, a lens (auto and non-auto), a cell phone part, a greenhouse component, a sun room component, a fire helmet, a safety shield, safety glasses, a gas pump part, a humidifier housing, a thermostat control housing, an air conditioner drain pan, an outdoor cabinet, a telecom enclosure or infrastructure, a Simple Network Detection System (SNIDS) device, a network interface device, a smoke detector, a component or device in a plenum space, a medical scanner, X-ray equipment, a component for a medical application or a device, an electrical box or enclosure, and an electrical connector, a construction or agricultural equipment, and a turbine blade.

In further aspects the article is a component of an aircraft interior or a train interior, an access panel, access door, air flow regulator, air gasper, air grille, arm rest, baggage storage door, balcony component, cabinet wall, ceiling panel, door pull, door handle, duct housing, enclosure for an electronic device, equipment housing, equipment panel, floor panel, food cart, food tray, galley surface, handle, housing for television, light panel, magazine rack, telephone housing, partition, part for trolley cart, seat back, seat component, railing component, seat housing, shelve, side wall, speaker housing, storage compartment, storage housing, toilet seat, tray table, tray, trim panel, window molding, window slide, a balcony component, baluster, ceiling panel, cover for a life vest, cover for a storage bin, dust cover for a window, layer of an electrochromic device, lens for a television, electronic display, gauge, or instrument panel, light cover, light diffuser, light tube, light pipes, mirror, partition, railing, refrigerator door, shower door, sink bowl, trolley cart container, trolley cart side panel, or window.

As described herein, the present inventors have unexpectedly discovered that a composition including specific amounts of the components described herein can provide certain advantageous properties. In particular, a combination of high mechanical strength, good dielectric properties, and good optical properties can be obtained. Therefore, a significant improvement is provided by the present disclosure.

This disclosure is further illustrated by the following examples, which are non-limiting.

### EXAMPLES

Materials used in the following examples are provided in Table 1.

TABLE 1

| Component | Description | Supplier |
|---|---|---|
| PMMA-1 | Poly(methyl methacrylate), having a melt flow rate of 16 g/10 minutes, | CHIMEI |
| | determined at 230° C. under a 3.8 kg load according to ASTM D1238; obtained | Corporation |
| | as ACRYREX ™ CM211 | |
| PMMA-2 | Poly(methyl methacrylate), having a melt flow rate of 7.3 g/10 minutes, | Lucite |
| | determined at 230° C. under a 3.8 kg load according to ISO 1133; obtained as | International |
| | LUCITE DIAKON ™ CLG902 | |
| IM-PMMA | Impact resistant poly(methyl methacrylate) obtained as ACRYLITE ™ | Roehm |
| | RESIST AG100 | |
| SEBS-1 | Polystyrene-poly(ethylene-butylene)-polystyrene radial triblock copolymer, | Kraton |
| | CAS Reg. No. 66070-58-4, having a polystyrene content of 12 to 14 weight | |
| | percent and a specific gravity of 0.94; obtained as KRATON ™ G1646 Resin | |
| SEBS-2 | Polystyrene-poly(ethylene-butylene)-polystyrene linear triblock copolymer, | Kraton |
| | CAS Reg. No. 66070-58-4, having a polystyrene content of 33 to 35 weight | |
| | percent; obtained as KRATON ™ MD6951 Resin | |
| SEBS-3 | Polystyrene-poly(ethylene-butylene)-polystyrene linear triblock copolymer, | Kraton |
| | CAS Reg. No. 66070-58-4, having a polystyrene content of 12 to 14 weight | |
| | percent; obtained as KRATON ™ G1657 Resin | |
| AO-1 | Tris(2,4-di-tert-butylphenyl) phosphite, CAS Reg. No. 31570-04-4, obtained | BASF |
| | as IRGAFOS ™ 168 | |
| AO-2 | Pentaerythritol tetrakis (3,5-di-tert-butyl-4-hydroxyhydrocinnamate), CAS | BASF |
| | Reg. No. 6683-19-8, obtained as IRGANOX ™ 1010 | |

Compositions were prepared by compounding on a Coperion ZSK-26Mc twin-screw extruder, with all components fed to the main throat. The composition was melt-kneaded, extruded, cooled through a water bath and pelletized. For comparative examples using PMMA-1, PMMA-2, or IM-PMMA alone, the compositions were injection molded as received. A typical extrusion profile is shown in Table 2.

TABLE 2

| Parameter | Unit | Value |
|---|---|---|
| Barrel Size | mm | 1000 |
| Die | mm | 4.4 |
| Feed (Zone 0) Temperature | \ | |
| Zone 1 temperature | ° C. | 50 |
| Zone 2 temperature | ° C. | 100 |
| Zone 3 temperature | ° C. | 195 |
| Zone 4 temperature | ° C. | 210 |
| Zone 5 temperature | ° C. | 210 |
| Zone 6 temperature | ° C. | 210 |
| Zone 7 temperature | ° C. | 210 |
| Zone 8 temperature | ° C. | 210 |
| Zone 9 temperature | ° C. | 210 |
| Zone 10 temperature | ° C. | 210 |
| Zone 11 temperature | ° C. | 210 |
| Zone 12 temperature | ° C. | 210 |
| Die temperature | ° C. | 200 |

The extruded pellets were molded into testing specimens after drying the extruded pellets at 120° C. for 3 hours using a Sumitomo DEMAG SE180EV injection molding machine or a FANUC S-2000i injection molding machine. Typical molding conditions are shown in Table 3.

TABLE 3

| Molding parameters | unit | Value |
|---|---|---|
| Pre-drying time | Hour | 4 |
| Pre-drying temperature | ° C. | 80 |
| Zone 1 temperature | ° C. | 200 |
| Zone 2 temperature | ° C. | 210 |
| Zone 3 temperature | ° C. | 210 |
| Nozzle temperature | ° C. | 220 |
| Mold temperature | ° C. | 30 |

Molded samples of the composition were evaluated according to the following test methods. Specific gravity was determined according to ASTM D792. Melt flow rate (MFR) was determined at 230° C. under a 2.16 kg load, according to ASTM D638. Tensile properties were characterized at a testing speed of 50 mm/min at a temperature of 23° C., according to ASTM D790. Flexural properties were characterized at a testing speed of 1.27 millimeters per minute (mm/min) at a temperature of 23° C. on 127×12.7×3.2 millimeter (mm) bars, according to ASTM D256. Heat deflection temperature (HDT) was determined under a 1.82 megapascal (MPa) load using 127×12.7×3.2 mm bars, according to ASTM D648. Notched izod impact Strength (NII) was determined in accordance with ASTM D648 under a load of 5.0 lbf at a temperature of 23° C., 0° C., −30° C., or −40° C. on 63.5×12.7×3.2 mm bars. Unnotched Izod impact strength was determined in accordance with ASTM D648 under a load of 5 lbf at a temperature of 23° C. 0° C., −30° C., or −40° C. on 63.5×12.7×3.2 mm bars. Dielectric constant (Dk) and dielectric loss (Df) was measured on 100×100×2 mm plaques at 1.9 GHz with a QWED split post dielectric resonator and an Agilent PNA network analyzer. Haze and transmittance were measured on 100×100×2 or 100×100×3 mm plaques, according to ASTM D 1003. Yellowness index (YI) was measured on 100×100×2 or 10×100×3 mm plaques, according to ASTM E313. Pencil hardness was performed using a PPH-1 model, 1 kg load, 450 angle, Mitsubishi pencil, and 100×100×2 mm plaques. The hardness is reported as the hardness of the hardest pencil that did not scratch the surface. The pencil hardness scale from softer to harder is 2B, B, HB, F, H, 2H, 3H, etc.

Table 4 shows the compositions and properties for Examples 1-7 and Comparative Examples 1-10. The amount of each component is provided as weight percent (wt %) based on the total weight of the composition.

TABLE 4

| | Unit | CE1 | E1 | E2 | E3 | E4 | CE2 | E5 | E6 | E7 |
|---|---|---|---|---|---|---|---|---|---|---|
| PMMA-1 | wt % | 100 | 95 | 90 | 80 | 70 | | | | |
| PMMA-2 | wt % | | | | | | 100 | 90 | 80 | 70 |
| SEBS-1 | wt % | | 4.85 | 9.85 | 19.85 | 29.85 | | 9.85 | 19.85 | 29.85 |
| SEBS-2 | wt % | | | | | | | | | |
| SEBS-3 | wt % | | | | | | | | | |
| AO-1 | wt % | | 0.075 | 0.075 | 0.075 | 0.075 | | 0.075 | 0.075 | 0.075 |
| AO-2 | wt % | | 0.075 | 0.075 | 0.075 | 0.075 | | 0.075 | 0.075 | 0.075 |
| IM-PMMA | wt % | | | | | | | | | |
| Prop. | | | | | | | | | | |
| Specific gravity | g/cm³ | 1.19 | 1.17 | 1.15 | 1.11 | 1.08 | 1.18 | 1.14 | 1.11 | 1.08 |
| MFR | g/10 min | 10.4 | 9.4 | 11.9 | 13.1 | 21.1 | 4.7 | 5.8 | 10.1 | 17.4 |
| Tens. mod. | MPa | 3385 | 3413 | 2789 | 2081 | 1368 | 3311 | 2668 | 1793 | 968 |
| Tens. elong., brk | % | 3.1 | 4.8 | 3.1 | 6.8 | 8.1 | 4.2 | 3.3 | 2.9 | 2.8 |
| Tens. strg, brk | MPa | 67.7 | 71.6 | 55.0 | 40.4 | 27.5 | 73.5 | 53.0 | 32.2 | 16.9 |
| Flex. Mod. | MPa | 3220 | 2880 | 2570 | 1740 | 1000 | 3050 | 2240 | 1390 | 442 |
| Flex. strg, yld | MPa | 98.3 | 101.0 | 77.0 | 43.1 | 21.8 | 75.1 | 73.8 | 6735 | 62.4 |
| HDT | ° C. | 68.5 | 71.9 | 67.5 | 65.1 | 63.0 | 75.1 | 73.8 | 67.5 | 62.4 |
| NII, RT | J/m | 12.8 | 21.5 | 24.7 | 29.8 | 50.3 | 13.6 | 27.3 | 30.2 | 40.6 |
| NII, 0° C. | J/m | 13.4 | 20.3 | 21.0 | 29.1 | 41.3 | 13.2 | 26.2 | 30.4 | 42.5 |
| NII, −30° C. | J/m | 13.6 | 16.7 | 15.6 | 25.8 | 30.7 | 13.2 | 18.4 | 26.0 | 34.2 |
| NII, −40° C. | J/m | 13.2 | 16.7 | 16.6 | 25.6 | 26.0 | 14.1 | 19.9 | 26.0 | 31.8 |
| UNII, RT | J/m | 216 | 243 | 235 | 547 | 834 | 235 | 291 | 625 | 791 |
| UNII, 0° C. | J/m | 217 | 226 | 220 | 505 | 967 | 239 | 276 | 672 | 988 |
| UNII, −30° C. | J/m | 232 | 216 | 223 | 439 | 706 | 241 | 276 | 480 | 786 |
| UNII, −40° C. | J/m | 228 | 203 | 222 | 314 | 384 | 239 | 232 | 371 | 410 |
| Haze, 2.0 mm | % | 2.8 | 3.9 | 4.0 | 3.4 | 7.7 | 2.0 | 3.4 | 6.5 | 13.4 |
| Trans., 2.0 mm | % | 92.7 | 93.0 | 92.2 | 92.8 | 92.9 | 93.5 | 92.8 | 92.8 | 92.8 |
| YI, 2.0 mm | | 0.60 | 0.52 | 0.87 | 0.62 | 0.69 | 0.36 | 1.08 | 0.74 | 0.70 |
| Haze, 3.0 mm | % | 3.5 | 4.4 | 6.6 | 6.2 | 19.4 | 2.2 | 4.5 | 7.7 | 24.6 |
| Trans., 3.0 mm | % | 93.5 | 92.5 | 91.3 | 92.4 | 92.4 | 93.4 | 92.3 | 92.3 | 92.4 |
| YI, 3.0 mm | | 0.16 | 0.61 | 1.14 | 0.83 | 0.83 | 0.40 | 1.41 | 1.02 | 0.90 |
| Dk | | 2.69 | 2.60 | 2.64 | 2.57 | 2.51 | 2.67 | 2.60 | 2.54 | 2.49 |
| Df | | 0.0093 | 0.0054 | 0.0079 | 0.0068 | 0.0054 | 0.0076 | 0.006 | 0.005 | 0.0043 |
| Pencil hardness | | 3H | B | B | <6B | <6B | 3H | B | <6B | <6B |

| | Unit | CE3 | CE4 | CE5 | CE6 | CE7 | CE8 | CE9 | CE10 |
|---|---|---|---|---|---|---|---|---|---|
| PMMA-1 | wt % | | 95 | 90 | 80 | 95 | 90 | 80 | 70 |
| PMMA-2 | wt % | | | | | | | | |
| SEBS-1 | wt % | | | | | | | | |
| SEBS-2 | wt % | | 4.85 | 9.85 | 19.85 | | | | |
| SEBS-3 | wt % | | | | | 4.85 | 9.85 | 19.85 | 29.85 |
| AO-1 | wt % | | 0.075 | 0.075 | 0.075 | 0.075 | 0.075 | 0.075 | 0.075 |
| AO-2 | wt % | | 0.075 | 0.075 | 0.075 | 0.075 | 0.075 | 0.075 | 0.075 |
| IM-PMMA | wt % | 100 | | | | | | | |
| Prop. | | | | | | | | | |
| Specific gravity | g/cm³ | 1.16 | 1.17 | 1.16 | 1.12 | 1.17 | 1.15 | 1.11 | 1.08 |
| MFR | g/10 min | 0.65 | 9.9 | 11.0 | 22.6 | 9.72 | 10.8 | 11.9 | 14.8 |
| Tens. mod. | MPa | 2362 | 3395 | 3009 | 1710 | 3249 | 3115 | 2428 | 1788 |
| Tens. elong., brk | % | 28.9 | 6.7 | 6.3 | 4.5 | 4.7 | 4.6 | 4.5 | 10.9 |
| Tens. strg, brk | MPa | 42.8 | 67.4 | 59.6 | 34.1 | 66 | 60.7 | 44.7 | 33.1 |
| Flex. Mod. | MPa | 2040 | 2890 | 2410 | 1120 | 2890 | 2560 | 1890 | 1310 |
| Flex. strg, yld | MPa | 70.4 | 103.0 | 82.6 | 33.7 | 96.8 | 80.8 | 49.8 | 30.9 |
| HDT | ° C. | 70.4 | 72.1 | 70.1 | 64.2 | 70.5 | 70 | 67.4 | 65.4 |
| NII, RT | J/m | 51.5 | 15.6 | 20.6 | 33.0 | 15.5 | 21.6 | 28.5 | 31.4 |
| NII, 0° C. | J/m | 42.5 | 16.2 | 23.2 | 26.2 | 16.2 | 23.4 | 28.7 | 33.9 |
| NII, −30° C. | J/m | 28.6 | 14.8 | 15.0 | 18.4 | 15.9 | 19.7 | 30.7 | 34.8 |
| NII, −40° C. | J/m | 24.1 | 14.8 | 15.4 | 15.0 | 16.8 | 21.9 | 33.7 | 40.3 |
| UNII, RT | J/m | 629 | 235 | 382 | 832 | 239 | 284 | 607 | 1100 |
| UNII, 0° C. | J/m | 459 | 227 | 258 | 536 | 227 | 249 | 541 | 762 |
| UNII, −30° C. | J/m | 320 | 162 | 247 | 257 | 231 | 253 | 509 | 756 |
| UNII, −40° C. | J/m | 315 | 205 | 236 | 243 | 238 | 245 | 517 | 723 |
| Haze, 2.0 mm | % | 2.0 | 42.6 | 69.8 | 94.5 | 10.2 | 5.6 | 6.2 | 8.3 |
| Trans., 2.0 mm | % | 92.3 | 76.5 | 67.7 | 56.3 | 91.5 | 92.2 | 91.8 | 91.5 |
| YI, 2.0 mm | | −0.03 | 11.5 | 14.6 | 18.8 | 1.4 | 1 | 1.5 | 1.6 |
| Haze, 3.0 mm | % | 3.2 | 64.9 | 88.4 | 99.1 | 14.7 | 8.7 | 8.3 | 12.4 |
| Trans., 3.0 mm | % | 91.8 | 70.2 | 57.3 | 45.3 | 90.1 | 91.3 | 91.2 | 91.1 |
| YI, 3.0 mm | | −0.26 | 15.8 | 20.4 | 21.0 | 1.9 | 1.3 | 1.9 | 2.3 |
| Dk | | 2.68 | 2.60 | 2.59 | 2.56 | 2.61 | 2.59 | 2.56 | 2.49 |
| Df | | 0.013 | 0.0054 | 0.0051 | 0.0046 | 0.006 | 0.0056 | 0.0056 | 0.0043 |
| Pencil hardness | | H | B | <6B | <6B | B | 4B | <6B | <6B |

Comparative Example 1 shows the properties for PMMA-1. Examples 1-4 show compositions of PMMA-1 and varying amounts of SEBS-1. As seen in Table 4, Dk and Df are both observed to decrease for each of Examples 1-4 compared to Comparative Example 1. The impact strength was observed to increase. Unexpectedly, the compositions of Examples 1-4 maintained a high degree of transparency (e.g., greater than 90%) and a low degree of haze. Relative to Comparative Example 3, which is a commercially available impact-modified PMMA, Dk and Df are both observed to decrease for each of Examples 1-4 compared to Comparative Example 3. The various mechanical properties were observed to have some dependence on the amount of SEBS included in the composition. Compared to Comparative Examples 4-6, it can be seen that use of SEBS having a lower polystyrene content as in Examples 1-4 can provide good transparency and haze.

Comparative Example 2 shows the properties for PMMA-2. Examples 5-7 show compositions of PMMA-1 and varying amounts of SEBS-1. As seen in Table 4. Dk and Df are both observed to decrease for each of Examples 5-7 compared to Comparative Example 2. The impact strength was observed to increase. Unexpectedly, the compositions of Examples 1-4 maintained a high degree of transparency (e.g., greater than 90%) and a low degree of haze.

Comparative Examples 7-10 show compositions that are comparable to the compositions of Examples 1-4, except that a linear block copolymer (SEBS-3) was used rather than a radial block copolymer (SEBS-1). The SEBS-3 block copolymer used in Comparative Examples 7-10 had the same styrene content as the SEBS-1 radial block copolymer used in Examples 1-4. As shown in Table 4, the compositions of Comparative Examples 7-10 exhibited significantly higher haze and yellowness at both 2 and 3 millimeter thicknesses compared to the compositions of Examples 1-4 when the radial block copolymer was used. The compositions of Comparative Examples 7-10 also exhibited reduced transmission compared to the compositions of Examples 1-4. It can therefore be seen that even when the styrene content is the same, the same optical properties are not achieved with a hydrogenated block copolymer having a linear architecture.

Accordingly, the compositions according to the present disclosure can advantageously provide a desirable combination of dielectric properties, mechanical properties, and optical properties when a particular hydrogenated block copolymer having a specific architecture and alkenyl aromatic content is included. A significant improvement is therefore provided by the present disclosure.

This disclosure further encompasses the following aspects.

Aspect 1: A thermoplastic composition comprising: 70 to 99 weight percent of poly(methyl methacrylate); and 1 to 30 weight percent of a radial hydrogenated block copolymer of an alkenyl aromatic and a conjugated diene having an alkenyl aromatic content of 10 to 20 weight percent based on the total weight of the hydrogenated block copolymer; wherein weight percent of each component is based on the total weight of the thermoplastic composition; wherein the combined amount of the poly(methyl methacrylate) and the hydrogenated block copolymer is at least 90 weight percent; and wherein a molded sample of the thermoplastic composition exhibits one or more of: a dielectric constant Dk of 2.45 to 2.75 at 1.9 GHz; a dielectric loss Df of less than 0.01 at 1.9 GHz; a transmission of greater than 90% at a thickness of 2 millimeters or 3 millimeters, according to ASTM D1003; a haze of less than 4% at a thickness of 2 millimeters, according to ASTM D1003; and a haze of less than 8% at a thickness of 3 millimeters, according to ASTM D100.

Aspect 2: The thermoplastic composition of aspect 1, wherein the hydrogenated block copolymer is a poly(styrene-ethylene/butylene-styrene) triblock copolymer.

Aspect 3: The thermoplastic composition of aspect 1 or 2, wherein the hydrogenated block copolymer has an alkenyl aromatic content of 10 to 15 weight percent based on the total weight of the hydrogenated block copolymer.

Aspect 4: The thermoplastic composition of any of aspects 1 to 3, comprising 75 to 99 weight percent of the poly(methyl methacrylate).

Aspect 5: The thermoplastic composition of any of aspects 1 to 4, comprising 1 to 25 weight percent of the hydrogenated block copolymer.

Aspect 6: The thermoplastic composition of any of aspects 1 to 5, comprising 75 to 99 weight percent, or 77 to 98 weight percent of the poly(methyl methacrylate); and 1 to 25 weight percent, or 2 to 23 weight percent of the hydrogenated block copolymer, wherein the hydrogenated block copolymer has an alkenyl aromatic content of 10 to 15 weight percent based on the total weight of the hydrogenated block copolymer.

Aspect 7: The thermoplastic composition of aspect 6, wherein the hydrogenated block copolymer is a poly(styrene-ethylene/butylene-styrene) triblock copolymer.

Aspect 8: The thermoplastic composition of any of aspects 1 to 7, further comprising an additive composition.

Aspect 9: The thermoplastic composition of any of aspects 1 to 8, further comprising an antioxidant.

Aspect 10: The thermoplastic composition of any of aspects 1 to 9, wherein the combined amount of the poly(methyl methacrylate) and the hydrogenated block copolymer is at least 92 weight percent, or at least 95 weight percent, or at least 97 weight percent, or at least 99 weight percent, based on the total weight of the composition.

Aspect 11: The thermoplastic composition of any of aspects 1 to 10, wherein the composition excludes impact modifiers other than the hydrogenated block copolymer.

Aspect 12: The thermoplastic composition of any of aspects 1 to 11, wherein a molded sample of the thermoplastic composition exhibits one or more of: a dielectric constant Dk of 2.45 to 2.75 at 1.9 GHz; a dielectric loss Df of less than 0.01 at 1.9 GHz; a transmission of greater than 90% at a thickness of 2 millimeters or 3 millimeters; a haze of less than 4% at a thickness of 2 millimeters; and a haze of less than 8% at a thickness of 3 millimeters.

Aspect 13: The thermoplastic composition of aspect 1, comprising 75 to 99 weight percent of the poly(methyl methacrylate); and 1 to 25 weight percent of a poly(styrene-ethylene/butylene-styrene) triblock copolymer having a styrene content of 10 to 15 weight percent based on the total weight of the hydrogenated block copolymer; wherein the combined amount of the poly(methyl methacrylate) and the poly(styrene-ethylene/butylene-styrene) triblock copolymer is at least 95 weight percent, based on the total weight of the composition; and wherein a molded sample of the thermoplastic composition exhibits one or more of: a dielectric constant Dk of 2.45 to 2.75 at 1.9 GHz; a dielectric loss Df of less than 0.01 at 1.9 GHz; a transmission of greater than 90% at a thickness of 2 millimeters or 3 millimeters; a haze of less than 4% at a thickness of 2 millimeters; and a haze of less than 8% at a thickness of 3 millimeters.

Aspect 14: A method for the manufacture of the thermoplastic composition of any of aspects 1 to 13, the method comprising melt-mixing the components of the composition.

Aspect 15: An article comprising the composition of any of aspects 1 to 13.

The compositions, methods, and articles can alternatively comprise, consist of, or consist essentially of, any appropriate materials, steps, or components herein disclosed. The compositions, methods, and articles can additionally, or alternatively, be formulated so as to be devoid, or substantially free, of any materials (or species), steps, or components, that are otherwise not necessary to the achievement of the function or objectives of the compositions, methods, and articles.

All ranges disclosed herein are inclusive of the endpoints, and the endpoints are independently combinable with each other. “Combinations” is inclusive of blends, mixtures, alloys, reaction products, and the like. The terms “first,” “second,” and the like, do not denote any order, quantity, or importance, but rather are used to distinguish one element from another. The terms “a” and “an” and “the” do not denote a limitation of quantity, and are to be construed to cover both the singular and the plural, unless otherwise indicated herein or clearly contradicted by context. “Or” means “and/or” unless clearly stated otherwise. Reference throughout the specification to “an aspect” means that a particular element described in connection with the aspect is included in at least one aspect described herein, and may or may not be present in other aspects. The term “combination thereof” as used herein includes one or more of the listed elements, and is open, allowing the presence of one or more like elements not named. In addition, it is to be understood that the described elements may be combined in any suitable manner in the various aspects.

Unless specified to the contrary herein, all test standards are the most recent standard in effect as of the filing date of this application, or, if priority is claimed, the filing date of the earliest priority application in which the test standard appears.

Unless defined otherwise, technical and scientific terms used herein have the same meaning as is commonly understood by one of skill in the art to which this application belongs. All cited patents, patent applications, and other references are incorporated herein by reference in their entirety. However, if a term in the present application contradicts or conflicts with a term in the incorporated reference, the term from the present application takes precedence over the conflicting term from the incorporated reference.

Compounds are described using standard nomenclature. For example, any position not substituted by any indicated group is understood to have its valency filled by a bond as indicated, or a hydrogen atom. A dash (“-”) that is not between two letters or symbols is used to indicate a point of attachment for a substituent. For example, —CHO is attached through carbon of the carbonyl group.

As used herein, the term “hydrocarbyl”, whether used by itself, or as a prefix, suffix, or fragment of another term, refers to a residue that contains only carbon and hydrogen. The residue can be aliphatic or aromatic, straight-chain, cyclic, bicyclic, branched, saturated, or unsaturated. It can also contain combinations of aliphatic, aromatic, straight chain, cyclic, bicyclic, branched, saturated, and unsaturated hydrocarbon moieties. However, when the hydrocarbyl residue is described as substituted, it may, optionally, contain heteroatoms over and above the carbon and hydrogen members of the substituent residue. Thus, when specifically described as substituted, the hydrocarbyl residue can also contain one or more carbonyl groups, amino groups, hydroxyl groups, or the like, or it can contain heteroatoms within the backbone of the hydrocarbyl residue. The term “alkyl” means a branched or straight chain, saturated aliphatic hydrocarbon group, e.g., methyl, ethyl, n-propyl, i-propyl, n-butyl, s-butyl, t-butyl, n-pentyl, s-pentyl, and n- and s-hexyl. “Alkenyl” means a straight or branched chain, monovalent hydrocarbon group having at least one carbon-carbon double bond (e.g., ethenyl (—HC═CH₂)). “Alkoxy” means an alkyl group that is linked via an oxygen (i.e., alkyl-O—), for example methoxy, ethoxy, and sec-butyloxy groups. “Alkylene” means a straight or branched chain, saturated, divalent aliphatic hydrocarbon group (e.g., methylene (—CH₂—) or, propylene (—(CH₂)₃—)). “Cycloalkylene” means a divalent cyclic alkylene group. —CₙH₂ₙ₋ₓ, wherein x is the number of hydrogens replaced by cyclization(s). “Cycloalkenyl” means a monovalent group having one or more rings and one or more carbon-carbon double bonds in the ring, wherein all ring members are carbon (e.g., cyclopentyl and cyclohexyl). “Aryl” means an aromatic hydrocarbon group containing the specified number of carbon atoms, such as phenyl, tropone, indanyl, or naphthyl. “Arylene” means a divalent aryl group. “Alkylarylene” means an arylene group substituted with an alkyl group. “Arylalkylene” means an alkylene group substituted with an aryl group (e.g., benzyl). The prefix “halo” means a group or compound including one more of a fluoro, chloro, bromo, or iodo substituent. A combination of different halo atoms (e.g., bromo and fluoro), or only chloro atoms can be present. The prefix “hetero” means that the compound or group includes at least one ring member that is a heteroatom (e.g., 1, 2, or 3 heteroatom(s)), wherein the heteroatom(s) is each independently N, O, S, Si, or P. “Substituted” means that the compound or group is substituted with at least one (e.g., 1, 2, 3, or 4) substituents that can each independently be a C₁₋₉ alkoxy, a C₁₋₉ haloalkoxy, a nitro (—NO₂), a cyano (—CN), a C₁₋₆ alkyl sulfonyl (—S(═O)₂-alkyl), a C₆₋₁₂ aryl sulfonyl (—S(═O)₂-aryl), a thiol (—SH), a thiocyano (—SCN), a tosyl (CH₃C₆H₄SO₂—), a C₃₋₁₂ cycloalkyl, a C₂₋₁₂ alkenyl, a C₅₋₁₂ cycloalkenyl, a C₆₋₁₂ aryl, a C₇₋₁₃ arylalkylene, a C₄₋₁₂ heterocycloalkyl, and a C₃₋₁₂ heteroaryl instead of hydrogen, provided that the substituted atom's normal valence is not exceeded. The number of carbon atoms indicated in a group is exclusive of any substituents. For example —CH₂CH₂CN is a C₂ alkyl group substituted with a nitrile.

While particular embodiments have been described, alternatives, modifications, variations, improvements, and substantial equivalents that are or may be presently unforeseen may arise to applicants or others skilled in the art. Accordingly, the appended claims as filed and as they may be amended are intended to embrace all such alternatives, modifications variations, improvements, and substantial equivalents.

1. A thermoplastic composition comprising:
70 to 99 weight percent of poly(methyl methacrylate); and
1 to 30 weight percent of a radial hydrogenated block copolymer of an alkenyl aromatic and a conjugated diene having an alkenyl aromatic content of 10 to 20 weight percent, preferably 10 to 15 weight percent, based on the total weight of the hydrogenated block copolymer;
wherein weight percent of each component is based on the total weight of the thermoplastic composition;
wherein the combined amount of the poly(methyl methacrylate) and the hydrogenated block copolymer is at least 90 weight percent; and
wherein a molded sample of the thermoplastic composition exhibits one or more of:
a dielectric constant Dk of 2.45 to 2.75 at 1.9 GHz;
a dielectric loss Df of less than 0.01 at 1.9 GHz;
a transmission of greater than 90% at a thickness of 2 millimeters or 3 millimeters, according to ASTM D1003;
a haze of less than 4% at a thickness of 2 millimeters, according to ASTM D1003; and
a haze of less than 8% at a thickness of 3 millimeters, according to ASTM D1003.

2. The thermoplastic composition of claim 1, wherein the radial hydrogenated block copolymer is a poly(styrene-ethylene/butylene-styrene) triblock copolymer.

3. The thermoplastic composition of claim 1, comprising 75 to 99 weight percent of the poly(methyl methacrylate).

4. The thermoplastic composition of claim 1, comprising 1 to 25 weight percent of the radial hydrogenated block copolymer.

5. The thermoplastic composition of claim 1, comprising
75 to 99 weight percent, or 77 to 98 weight percent of the poly(methyl methacrylate); and
1 to 25 weight percent, or 2 to 23 weight percent of the radial hydrogenated block copolymer, wherein the hydrogenated block copolymer has an alkenyl aromatic content of 10 to 15 weight percent based on the total weight of the hydrogenated block copolymer.

6. The thermoplastic composition of claim 5, wherein the radial hydrogenated block copolymer is a poly(styrene-ethylene/butylene-styrene) triblock copolymer.

7. The thermoplastic composition of claim 1, further comprising an additive composition.

8. The thermoplastic composition of claim 1, further comprising an antioxidant.

9. The thermoplastic composition of claim 1, wherein the combined amount of the poly(methyl methacrylate) and the radial hydrogenated block copolymer is at least 92 weight percent, or at least 95 weight percent, or at least 97 weight percent, or at least 99 weight percent, based on the total weight of the composition.

10. The thermoplastic composition of claim 1, wherein the composition excludes impact modifiers other than the radial hydrogenated block copolymer.

11. The thermoplastic composition of claim 1, wherein the composition excludes a linear hydrogenated block copolymer.

12. The thermoplastic composition of claim 1, wherein the radial hydrogenated block copolymer has a specific gravity of greater than or equal to 0.92 g/cm³.

13. The thermoplastic composition of claim 1, comprising
75 to 99 weight percent of the poly(methyl methacrylate); and
1 to 25 weight percent of a poly(styrene-ethylene/butylene-styrene) triblock copolymer having a styrene content of 10 to 15 weight percent based on the total weight of the hydrogenated block copolymer;
wherein the combined amount of the poly(methyl methacrylate) and the poly(styrene-ethylene/butylene-styrene) triblock copolymer is at least 95 weight percent, based on the total weight of the composition.

14. A method for the manufacture of the thermoplastic composition of claim 1, the method comprising melt-mixing the components of the composition.

15. An article comprising the composition of claim 1.
